(19) United States
(12) Patent Application Publication
(10) Pub. No.: US 2026/0299567 A1
(43) Pub. Date: Oct. 1, 2026

(54) STOCHASTIC FAILURE PREDICTION MODELS AND THEIR USE IN OPTICAL PROXIMITY CORRECTION AND MASK VALIDATION

(71) Applicant: Intel Corporation, Santa Clara, CA (US)

(72) Inventors: Chihhui Wu, Washougal, WA (US); Yenchia Chen, Vancouver, WA (US); Nabil Laachi, Camas, WA (US); Sayak Dasgupta, Portland, OR (US); Dhananjay Mohan Bhawe, Portland, OR (US); Abhinav Narasingam, Portland, OR (US); Nicholas W. Bigelow, Portland, OR (US); Yong-Wook Shin, Portland, OR (US); Arin Greenwood, Portland, OR (US); Karthik Periagaram, Hillsboro, OR (US); Raghunathan Dhananjay Vinjamur, Portland, OR (US); Anjan Vinjamoor Raghunathan, Portland, OR (US)

(73) Assignee: Intel Corporation, Santa Clara, CA (US)

(21) Appl. No.: 19/092,244

(22) Filed: Mar. 27, 2025

(51) Int. Cl. G05B 19/418

(52) U.S. Cl. CPC G05B 19/41875; G05B 2219/32368

(57) ABSTRACT

Adjustments to edges in an integrated circuit layout are made during optical proximity correction based on trained stochastic failure prediction models. The stochastic failure prediction models generate average edge placement errors and standard deviations of edge placements for as-manufactured features that correspond to an edge in an integrated circuit layout. A defect rate model calibrated for a particular integrated circuit manufacturing process generates a predicted defect rate for a layout geometry based on information generated by the stochastic failure prediction models. Optical proximity correction can utilize multiple stochastic failure prediction models that model multiple defect modes to determine which edges of an integrated circuit layout are to be adjusted in a photomask layout to reduce the defect rate. The stochastic failure prediction models can also be used during mask validation to identify regions of the photomask layout that are predicted to have high defect rates.

### BACKGROUND

Photolithography involves coating a wafer or other substrate with photoresist, exposing the resist to light through a photomask, and developing the resist to transfer circuit patterns from the photomask to the wafer. Photolithography patterning defects can occur in as-manufactured features, such as bridging defects that cause unintended electrical shorts. Optical proximity correction (OPC) is one approach to reduce the occurrences of such defects.

### BRIEF DESCRIPTION OF THE DRAWINGS

FIGS. 1A-1B, 2A-2F, and 3A-3D present an overview of various aspects of semiconductor device manufacturing.

FIGS. 4A-4C illustrate example photolithography patterning stochastic defects that the technologies described herein attempt to mitigate.

FIG. 5 is an example method of performing optical proximity correction and mask validation utilizing stochastic failure prediction and defect rate models.

FIG. 6 is a graph illustrating the correlation between the defect rate and critical dimension mean-to-standard deviation ratios for an integrated circuit manufacturing process.

FIGS. 7A-7B illustrate an example use of stochastic failure prediction models during optical proximity correction.

FIG. 8 is a block diagram of a first example computing system for performing optical proximity correction and mask validation in integrated circuit layout using stochastic failure prediction models.

FIG. 9 is a first example method of performing optical proximity correction in an integrated circuit layout using stochastic failure prediction models.

FIG. 10 is a second example method of performing optical proximity correction in an integrated circuit layout using stochastic failure prediction models.

FIG. 11 is a block diagram of a second example computing system for performing optical proximity correction and mask validation in integrated circuit layout using stochastic failure prediction models.

FIG. 12 is a block diagram of an example processor unit to execute computer-executable instructions as part of implementing technologies described herein.

### DETAILED DESCRIPTION

Semiconductor manufacturing has become increasingly complex over the years. Since the turn of the century, the minimum feature size has shrunk by over an order of magnitude as the industry has progressed from the 130 nm to the 3 nm technology nodes. At the same time, processor complexity has dramatically increased. Current flagship products can have tens of billions of transistors. With this many transistors on an integrated circuit die, yields can be limited by photolithography patterning stochastic defects. These stochastic defects are rare and can occur at such low rates—less than one in one billion (i.e., a defect rate of less than 10⁻⁹)—that the frequencies at which they occur are difficult to measure and predict.

Described herein are technologies for utilizing stochastic failure prediction models to predict defect rates of low-frequency photolithography patterning defects. The stochastic failure prediction models comprise edge placement and edge variability sub-models. The stochastic failure prediction models are compact and computationally efficient, allowing for their use in full-chip optical proximity correction (OPC) and photomask validation. During OPC, stochastic failure prediction models are used alongside a defect rate model to predict defect rates for layout geometries within an integrated circuit layout. If a predicted defect rate is greater than a defect rate threshold, one or more edges in the layout geometry may be adjusted in the photomask layout in an attempt to reduce the defect rate of the layout geometry. In some embodiments, defect rates are predicted for variations of a layout geometry and one or more edges are adjusted based on the layout geometry variation having the lowest predicted defect rate. At the photomask validation stage, the stochastic failure prediction models and defect rate model are used to predict defect rates for layout geometries in the photomask layout. Layout geometries having predicted defect rates greater than a defect rate threshold are identified as likely defect sources.

The technologies disclosed herein can have the following advantages. First, the use of stochastic failure prediction models can be more accurate in predicting rare photolithography patterning defects than simulating the optical response or resist signal contrast of layout geometries. Second, the use of compact and computationally efficient stochastic failure prediction models provides a more scalable optical proximity correction solution than those that use rule-based sizing. Third, the use of stochastic failure prediction models in optical proximity correction can result in higher quality photomasks and improved integrated circuit product yields. Fourth, adoption of the disclosed technologies in the development of critical and challenging layers in integrated circuit manufacturing processes can reduce technology development times.

In the following description, specific details are set forth, but embodiments of the technologies described herein may be practiced without these specific details. Well-known circuits, structures, and techniques have not been shown in detail to avoid obscuring an understanding of this description. “An embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to embodiments of the present disclosure, are synonymous.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

Certain terminology may also be used herein for reference only and thus are not intended to be limiting. For example, terms such as “left,” “right,” “up,” and “down” refer to directions in the Figures to which reference is made. Terms such as “top” and “bottom” describe the orientation and/or location of polygons, edges, layers, or components, within a consistent but arbitrary frame of reference, which is made clear by reference to the text and the associated Figures describing the polygons, edges, layers, or components, etc. under discussion. Such terminology may include the words specifically mentioned above, derivatives thereof, and words of similar import.

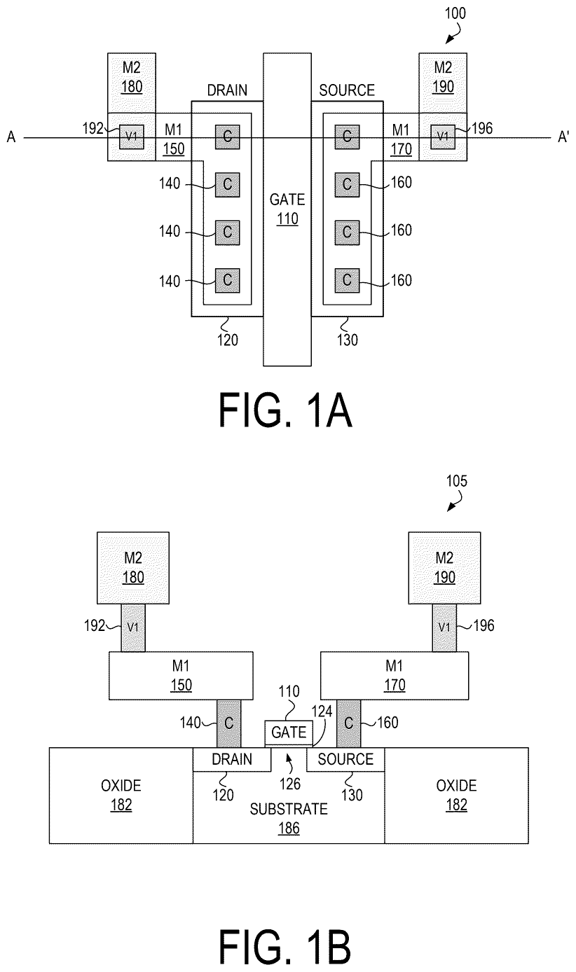

FIGS. 1A-1B, 2A-2F, and 3A-3D present an overview of various aspects of semiconductor device manufacturing. FIG. 1A illustrates the physical design of an example planar transistor. As will be discussed in greater detail below, the physical design of an integrated circuit is used to generate the photomasks that will be used during manufacturing to print the features on a wafer needed to implement an integrated circuit design. The physical design is typically a set of polygons drawn at various layers, such as a gate layer, a contact layer, and a metal-1 layer.

Transistor 100 is a field-effect-transistor (FET), the transistor type used in most modern semiconductor devices. Transistor 100 comprises gate 110, drain 120, and source 130 regions. The gate region of a FET can be thought of as an “on-off” switch that controls the flow of current between the drain and source regions. When gate 110 is “off”, there is no (or little) current flowing through a channel region 126 that connects drain 120 to source 130. When gate 110 is “on”, current readily flows through the channel region 126. Transistor 100 is connected to other transistors by a set of interconnect layers stacked vertically on top of transistor 100. Contacts 140 connect drain 120 to an L-shaped segment of a first metal layer (M1 segment 150), and contacts 160 connect source 130 to M1 segment 170. M1 segments 150 and 170, in turn, are connected to second metal layer (M2) segments 180 and 190 by vias 192 and 196, respectively, belonging to a first layer of vias (V1). In general, metal layer thicknesses increase as one moves up the interconnect stack, with thinner lower-level metals being generally used for local routing of signals and thicker upper-level metals being used for global signal routing and power/ground planes. For simplicity, FIG. 1A shows only two levels of metal. Current semiconductor manufacturing processing can have up to 15 metal interconnect layers.

FIG. 1B illustrates an example cross-section of the planar transistor of FIG. 1A taken along the line A-A′. Cross-section 105 shows gate 110 separated from drain 120 and source 130 regions by high-k dielectric layer 124, which electrically insulates gate 110 from the channel region 126 that connects drain 120 and source 130. Transistor 100 is in substrate region 186 and is insulated from adjacent transistors by oxide regions 182. The planar transistor illustrated in FIGS. 1A and 1B is just one type of transistor topography, the planar nature of the transistor reflecting that the gate, source, and drain regions are located on or are adjacent to a relatively planar surface. Another type of transistor topography is the non-planar transistor topography used in FinFETs, which are used extensively in cutting-edge manufacturing processes. FinFETs are field-effect transistors that operate under the same general principle as planar FET transistors—a gate controls the flow of current between drain and source region—with the variation that the gate wraps around one or more fins that extend vertically upwards from the wafer surface. Gate-all-around FETs (GAAFETs) and nanoribbon or nanosheet transistors are two other types of non-planar transistor topographies that are expected to be used in upcoming semiconductor manufacturing processes.

Essential to semiconductor manufacturing is the process of photolithography, by which patterns are transferred from a photomask (or mask) onto a wafer. As previously mentioned, masks are used to define the shape and location of various features to be patterned on a wafer for a given process layer. For example, a first mask defines where oxide regions are located, a second mask defines where high-k dielectrics that are part of transistor gates will be located, another mask defines the location of source and drain regions, and yet another mask defines where contacts will be placed. Additional masks are used to define the metal layers and intervening via layers.

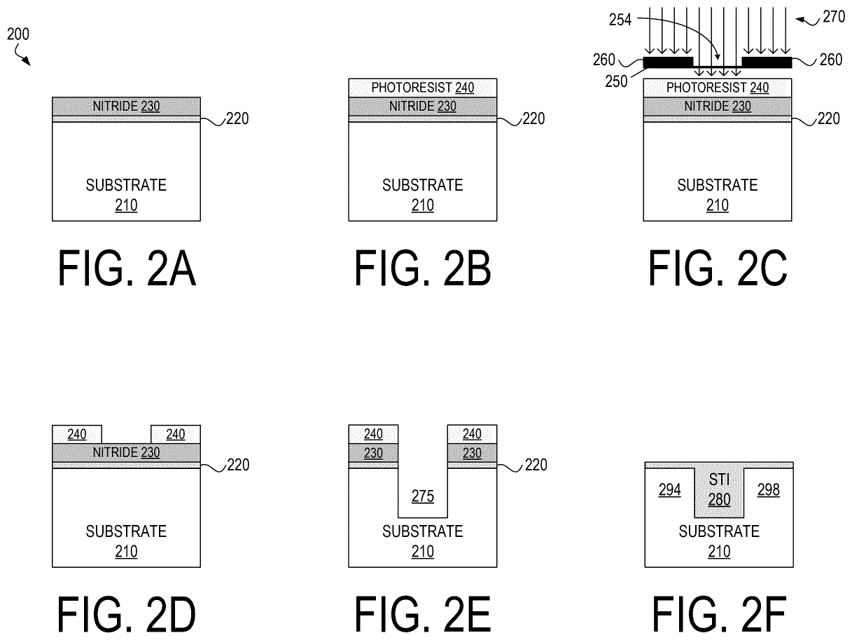

FIGS. 2A-2F illustrate an example photolithography process. Process 200 illustrates how the oxide regions 182 in FIG. 1B can be defined using photolithography. In FIG. 2A, a silicon dioxide layer 220 is thermally grown across the top of a silicon substrate (substrate 210) of a wafer. A silicon nitride layer (nitride layer 230), a protective layer, is deposited on top of silicon dioxide layer 220. In FIG. 2B, photoresist 240 is deposited on top of nitride layer 230. A photoresist is a material whose reactance to an etchant or solvent increases (if a positive photoresist) or decreases (negative photoresist) upon exposure to light. In process 200, photoresist 240 is a positive photoresist. In FIG. 2C, mask 250 with patterns 260 is positioned over the wafer and exposed to light 270. The light 270 passes through transparent region 254 of mask 250 and exposes photoresist 240. The patterns 260 are opaque to the light 270 and the photoresist regions under patterns 260 are not exposed to the light 270. In FIG. 2D, photoresist 240 is chemically developed and the portions of the photoresist 240 that were exposed to the light 270 are dissolved. The remaining unexposed portions of the photoresist 240 can now act as an on-wafer mask to allow for selective processing of the wafer. In FIG. 2E, the wafer is subjected to an etch process that removes a portion of the nitride layer 230, the silicon dioxide layer 220, and the substrate 210 to create trench 275. In FIG. 2F, the photoresist and nitride layers are removed, and silicon dioxide is formed in the trench to create a shallow trench isolation (STI) region 280 that serves to electrically isolate transistors formed in regions 294 and 298 from each other.

As masks are the means by which features of an integrated circuit design are realized, any semiconductor device design must ultimately be reduced to a physical design, the level of design abstraction from which masks are generated. The physical design of an integrated circuit to be manufactured is often referred to as a “layout.” The physical design of an integrated circuit can also be referred to as an integrated circuit layout. Electronic design automation (EDA) tools allow processor architects and circuit designers to design at levels of abstraction above the physical design level. They are thus spared from the drudgery of having to draw polygons in layout tools to realize their designs. Architects typically define their designs using a hardware design language (HDL), such as VHDL or Verilog. Once they have verified that their designs perform as desired, a physical design can be generated automatically from an HDL description of their design using a library of standard cell layouts (layouts of integrated circuit building blocks, such as logic gates and memory bitcells). Circuit designers seeking performance or functionality not available using standard cells may enter their designs into a schematic capture tool. Once their custom designs are finalized, the circuit schematics are handed off to layout designers who manually craft the custom physical designs.

Regardless of whether a physical design is generated automatically or manually, it must conform to a set of layout design rules established for a manufacturing process. Design rules are constraints that a physical design must follow to ensure manufacturability. Most design rules express a minimum width or space for a layout feature or dimension, such as, “gate length ≥10 nm,” “source/drain diffusion enclosure of a contact ≥16 nm,” and “space between metal-1 traces ≥20 nm.” Design rules represent a trade-off between feature density and manufacturability. Being able to print smaller feature sizes can mean more die can be packed onto a wafer, but if the process cannot reliably print the smaller features, the resulting reduction in wafer yield can more than offset the cost reductions gained by being able to print more die on a wafer.

Once a physical design is clear of design rule violations and has passed other design validation checks, it is passed to the mask generation phase of an EDA flow. The mask generation phase is far from trivial due to the wavelength of light used in photolithography (λ=193 nm for deep ultraviolet (UV), λ=13.5 nm for extreme UV) being greater than or on scale with the minimum feature sizes (tens of nanometers) of current processes. The minimum feature size that can be produced accurately in a photolithographic process is limited by the wavelength of the light source used. The semiconductor industry has developed resolution enhancement technologies (RET) to allow for the production of features having dimensions well below or on scale with the wavelength of a photolithographic light source. A first set of RET techniques works to increase resolution and/or depth of focus, and a second set of RET techniques compensates for distortion effect due to producing features with a wavelength larger than or on scale with minimum feature sizes as well as those inherent in deposition, etching, and other process steps. The first set includes techniques such as phase-shift masks and double-patterning, and the second set includes optical proximity correction (OPC).

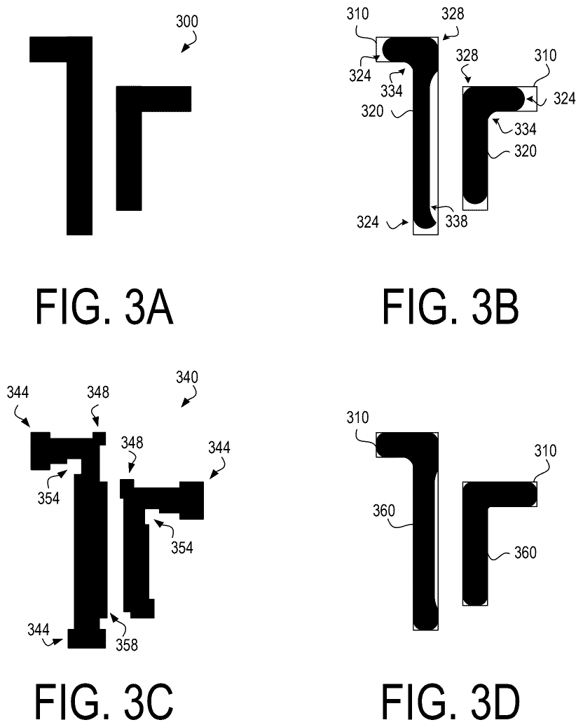

FIGS. 3A-3D illustrate differences between features printed on a mask and those produced on a wafer (or as-manufactured features, as-processed features) due to process distortion effects and the use of optical proximity correction to counter those effects. FIG. 3A illustrates polygons 300 of a gate layer that are part of a physical design before being subjected to an OPC process. FIG. 3B illustrates a simplified view of how as-produced features corresponding to polygons 300 may appear. Outlines 310 represent the boundaries of polygons 300 and shapes 320 represent the corresponding as-produced features. It can be seen that feature segment 338 is narrowed due to the presence of a nearby neighboring feature, ends 324 and exterior corners 328 are rounded off, and interior corners 334 are filled in. FIG. 3C illustrates example modified polygons 340 generated by applying an OPC process to polygons 300. Modified polygons 340 are more complex than the polygons 300. Modified polygons 340 include “dog-bone” corrections 344 that compensate for end-rounding, “ear” corrections 348 that compensate for exterior corner-rounding, “mouse-bite” corrections 354 that compensate for interior corner-rounding, and thickening corrections 358 that compensate for the presence of nearby neighboring features. FIG. 3D illustrates a simplified view of how features produced from a mask including the modified polygons 340 may appear on a wafer. Outlines 310 again represent the boundaries of the polygons 300. As can be seen, modification of polygons 300 by the OPC process results in as-manufactured shapes 360 that are closer to the shape and size of polygons 300. The ends and corners of the as-manufactured shapes 360 are less rounded off, the interior corners are less filled in, and the impact of nearby neighbors is reduced.

While OPC generation (and other RET techniques) have allowed minimum feature sizes to scale in successive technology nodes, the use of OPC does not come without its costs. OPC generation is computationally intensive. OPC recipes can be based on physical models of various processing steps (photolithography, diffusion, etch, deposition, etc.), or be rule-based models that generate OPC features based on individual physical design feature characteristics (width, length, shape, nearest-neighbor characteristics) without relying on the physics of the underlying process steps. The application of model-based OPC recipes to a complete physical design can involve the application of physical models to over 10 billion shapes at the gate layer alone and to billions of additional shapes over the remaining layers. Further, the generation of rule-based OPC models, which may save some of the computational complexity of model-based OPC generation, can be a complex affair. Generation of rule-based OPC recipes can be based on trial-and-error due to lack of a full understanding of the complex physics and chemistries at play in the development of cutting-edge processing technologies. This trial-and-error can comprise iteratively manufacturing features corresponding to variations of candidate OPC recipes and seeing which recipes produce the best results.

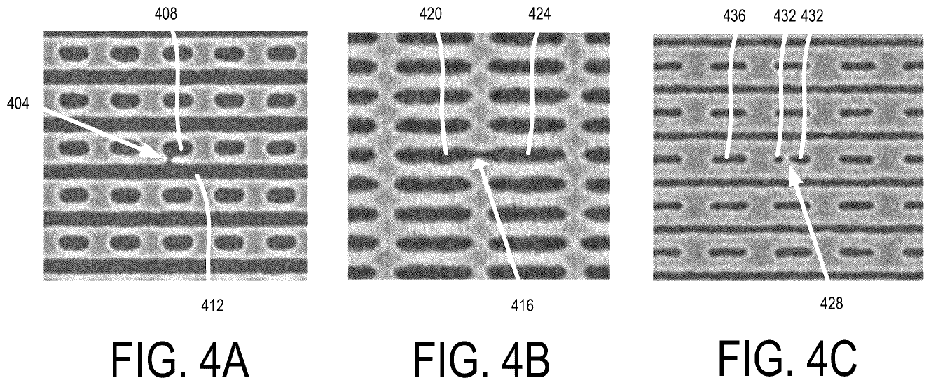

FIGS. 4A-4C illustrate example photolithography patterning stochastic defects that the technologies described herein attempt to mitigate. FIG. 4A illustrates a side-to-side bridging defect 404 in which a feature 408 connects with a neighboring feature 412. FIG. 4B illustrates an end-to-end bridging defect 416 in which ends of neighboring features 420 and 424 are connected. FIG. 4C illustrates a mini or scum defect 428 in which a feature intended to be formed as a singular feature (such as feature 436) is formed as separate features 432.

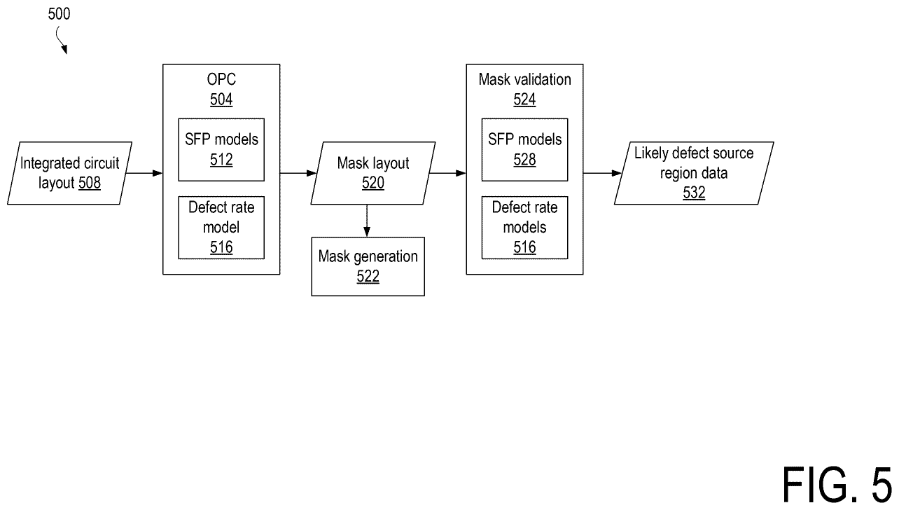

FIG. 5 is an example method of performing optical proximity correction and mask validation utilizing stochastic failure prediction and defect rate models. At stage 504 of method 500, optical proximity correction is performed on an integrated circuit layout 508 to generate a photomask layout (mask layout 520), which is the physical design of an integrated circuit layout used for photomask or reticle generation. The mask layout 520 can comprise polygon edges that are adjusted relative to their position in the integrated circuit layout 508. The selection of polygon edges that are to be adjusted in the mask layout 520 relative to the integrated circuit layout 508 is based on one or more stochastic failure prediction models (SFP models 512) and a defect rate model 516 applied to the integrated circuit layout 508 during optical proximity correction.

The defect rate model 516 can be a linear regression model, polynomial regression model, a piecewise linear or polynomial regression models, or any other suitable model that relates the defect rate of a critical dimension of an integrated circuit design to the ratio of the mean to the standard deviation of a set of measurements of the critical dimension in as-manufactured features. The critical dimension can be any feature in the integrated circuit layout 508 and is usually a width of a feature or a space between features. Although the term “critical dimension” typically refers to the smallest features in an integrated circuit process (e.g., gate width and space, M1 width and space), because the stochastic failure prediction models and defect rate model can be applied to any feature in an integrated circuit layout, the term “critical dimension” as used herein can refer to any feature of an integrated circuit layout. As used herein, the terms “critical dimension” and “dimension” in the context of an integrated circuit layout are used interchangeably.

In embodiments where the defect rate model 516 comprises a linear regression model, the linear regression model has the form:

$${log}_{10} ( defect rate ) = c 0 + c 1 * \frac{mean ( CD )}{stddev ( CD )} , \qquad ( Eq . 1 )$$

where c0 and c1 are linear regression coefficients, mean(CD) is the mean of a critical dimension, stddev(CD) is the standard deviation of the critical dimension, and defect rate is a predicted defect rate for the critical dimension.

As will be discussed below, the defect rate model 516 is used to generate a predicted defect rate during optical proximity correction and mask validation. But before a defect rate model can be used, it needs to be calibrated for a given process technology.

The calibration of a defect rate model is based on critical dimension measurements taken from scanning electron microscope (SEM) images of integrated circuit structures. Defect rate model calibration can involve collecting a large number of measurements for the same pattern of as-manufactured features. For example, more than one million measurements are needed to quantify a pattern that has a defect rate on the order of 10⁻⁶. Defect rate model calibration also demands a high degree of defect classification accuracy as the defect misclassification rate needs to be lower than the defect rate. To help address these issues, high-throughput defect inspection metrology tools with large fields of view (FOVs) can be used in conjunction with probability modeling photomasks to capture a large number of repeated patterns in individual SEM images.

Probability modeling photomasks contain repeated instances of layout geometries that mimic layout geometries of interest, such as layouts comprising minimum-sized critical dimensions or patterns that may be challenging for a process to produce reliably. The SEM images shown in FIGS. 4A-4C comprise features manufactured using probability modeling photomasks. The dimensions of individual features in the repeated geometries can be varied in the probability modeling photomasks. In particular, the sizes of the smallest features in the layout geometries in the probability modeling photomasks can be varied about the sizes that a process is expected to reliably produce in order to induce stochastic defects. For example, if a probability modeling photomask comprises patterns mimicking the M1 layout in a memory bitcell, the photomask can comprise variations of the M1 bitcell layout in which M1 polygon widths and spaces vary, with some M1 widths and spaces being smaller than what the manufacturing process is expected to reliably produce. In some embodiments, in addition or alternatively to collecting SEM images of integrated circuit structures manufactured using probability modeling photomasks, SEM images used for calibrating defect rate models can be collected from individual integrated circuit dies manufactured across a plurality of wafers.

From the collected SEM images, the defect rate of a particular defect mode (e.g., side-to-side M1 bridging defects) and a set of critical dimension measurements of particular as-manufactured feature (e.g., M1 width) for a particular pattern (e.g., memory bitcell) for a particular size of the particular feature (e.g., M1 width=20 nm) are determined. The defect rate is calculated as the number of identified defects divided by the number of patterns analyzed. The measured size of an as-manufactured feature, although intended to be identical across the various instances of the as-manufactured feature, varies due to the stochastic nature of the photolithographic patterning process. The measurements of the same critical dimension across replicated instances of the particular pattern having the same feature size provides a distribution of measured critical dimension sizes. Mean and standard deviation values for the critical dimension can be determined from this distribution of measurements.

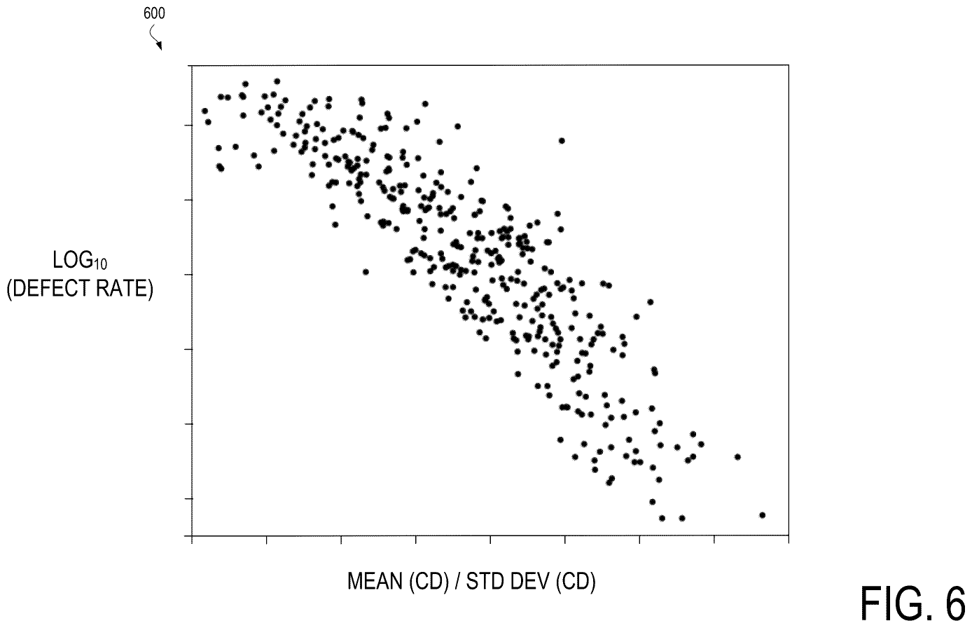

FIG. 6 is a graph illustrating the correlation between the defect rate and critical dimension mean-to-standard deviation ratios across various geometries, critical dimension sizes, and wafer exposure conditions (scanner focus and dose) for a particular integrated circuit manufacturing process. Each data point in the graph 600 is associated with a geometry, critical dimension size, and wafer exposure conditions triplet. Polynomial regression can be applied to the data points to derive an equation that models the relationship between defect rate and the critical dimension mean-to-standard deviation ratio. In some embodiments, a linear regression approach that yields a linear regression model having the form of Eq. (1) can be used. In other embodiments, a piecewise polynomial regression approach can be applied to the data points that yields different polynomial equations that model the defect rate to critical dimension mean-to-standard deviation ratio over different defect rate ranges. In some embodiments, the polynomial equation in a piecewise polynomial regression can for a particular defect rate range can be a linear equation. The defect rate models disclosed herein are not limited to polynomial and linear relationships. In some embodiments, regression approaches other than linear or polynomial regressions approaches can be used to derive defect rate models that express the defect rate to critical dimension mean-to-standard deviation ration relationship in other than linear or polynomial form.

With a defect ratio model calibrated for a given manufacturing process, the defect rate of a critical dimension in an integrated circuit layout can be inferred by determining a mean-to-standard deviation ratio of the corresponding as-manufactured feature. The correlation between defect rate and critical dimension mean-to-standard deviation ratio is extremely useful because it is much more costly to measure defect rates lower than 10⁻⁹ (which requires more than one billion measurements of as-manufactured replicated geometries), than it is to measure a mean-to-standard deviation ratio for an as-manufactured feature (which can be accurately estimated with narrow confidence intervals using a much lower number of measurements, such as on the order of one hundred measurements).

Returning to FIG. 5, with a defect rate model calibrated for a particular semiconductor manufacturing process, if the defect rate model can be provided a predicted mean-to-standard deviation ratio for an as-manufactured feature, the defect rate model can provide a predicted defect rate for the as-manufactured feature. The SFP models 512 can provide such ratios. But first, the SFP models 512 must be calibrated to the same manufacturing process as the defect rate model 516.

The stochastic failure prediction models described herein, including SFP models 512 comprise two sub-models, an edge placement sub-model and edge variability sub-model. The output of the edge placement sub-model is information indicating the average placement of an edge of an as-manufactured feature relative to the location of the edge in the as-manufactured feature in the absence of any manufacturing process distortions or variability. Put another way, the output of the edge placement sub-model indicates an average edge placement error—how much, on average, an edge in an as-manufactured feature is physically shifted relative to the position of the corresponding edge in an integrated circuit layout. The output of the edge variability sub-model is information indicating a standard deviation in the placement of an edge of the as-manufactured feature relative to the placement of the edge in the as-manufactured feature in the absence of any manufacturing process distortions or variability.

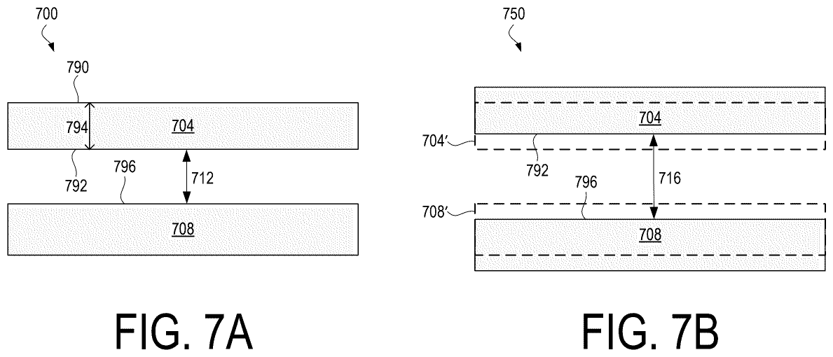

When the SFP models 512 are applied to edges in an integrated circuit layout, the generated average edge placement information and edge placement standard deviation information can be used to determine the means and standard deviations of as-produced feature sizes associated with edges. For example, with reference to FIG. 7A, a mean and standard deviation of the width of an as-manufactured feature that corresponds to a first polygon 704 in FIG. 7A can be determined by having SFP models generate average edge placement information and standard deviation edge placement information for edges 790 and 792 of the first polygon 704. The mean of the width of the as-manufactured feature corresponds to the width 794 of the first polygon 704. The mean and standard deviation values for as-manufactured features can be used to determine a predicted defect rate for the as-produced features using Eq. 1. Thus, the SFP models 512 provide a way to quickly predict the defect rate for an as-produced feature or features corresponding to a particular layout feature or geometry.

The SFP models 512 can comprise multiple stochastic failure prediction models, with individual SFP models modeling a defect rate for a particular defect mode (e.g., bridging) for a particular layer (e.g., gate, M1) in a manufacturing process. Thus, in some embodiments, the SFP models 512 can comprise multiple models that predict defect rates for different defect modes for a single layer.

Stochastic failure prediction models can model various defect modes, including bridging defects in which adjacent features are unintentionally connected, mini defects (sub-resolution defects such as nano-bridges, small particles, voids), toploss defects (defects in which the top portion of a patterned structure is excessively thinned or removed), scum defects (defects arising from residual photoresist material being left behind after resist development), and fallen line defects (defects arising from the collapse of high aspect-ratio photoresist or metal lines). These defects can create unintentional electrical shorts or opens in integrated circuit components or create other issues (e.g., increase metal interconnect resistance) that cause integrated circuits to not perform as intended. Some stochastic failure prediction models can be limited to a specific geometrical aspect for a defect mode, such as side-to-side bridging (see FIG. 4A), end-to-end bridging (see FIG. 4B), etc. For via or contact layers that comprise mostly holes, the stochastic failure prediction models can predict missing via or blocked via defects, wherein an intended via or contact is not formed or is only partially formed, respectively.

In some embodiments, the stochastic failure prediction sub-models are machine learning models. The use of machine learning models is advantageous in that they can be both computationally efficient and provide accurate defect rates predictions. In some embodiments, the machine learning models can be calibrated using two-dimensional optical images that are generated from lithography models.

Once the SFP models 512 are calibrated, they can be used in the OPC and mask validation stages of method 500 to predict defect rates for geometries in the integrated circuit layout 508. To predict a defect rate for critical dimension in an integrated circuit layout 508, average edge placement and edge placement standard deviations for one or more edges corresponding to the critical dimension can be determined using the SFP models 512. The mean and standard deviation values for the critical dimension can be determined based on the average edge placement and edge placement standard deviations for the one or more edges. These values can then be plugged into the defect rate model 516 to generate a predicted defect rate for the critical dimension.

FIGS. 7A-7B illustrate an example use of stochastic failure prediction models during optical proximity correction. FIG. 7A illustrates a layout geometry 700 comprising a first polygon 704 and a second polygon 708 belonging to an M1 layer. A spacing 712 between edge 792 of the first polygon 704 and edge 796 of the second polygon 708 is desired to be about 20 nm in the corresponding as-manufactured M1 features and a defect rate for this M1 spacing critical dimension is desired to be less than 10⁻¹⁰. Applying a M1 side-to-side bridging stochastic failure prediction model to the edges 792 and 796 generates average edge placement and standard deviation edge placement information (σ₁, σ₂) for the edges 792 and 796. From this information, a mean value mean(CD) for the spacing 712 between as-manufactured features associated with first polygon 704 and second polygon 708 is determined. The M1 shorting defect rate for the M1 spacing 712 is calculated using the following equation:

$${log}_{10} ( defect rate ) ∼ c 0 + c 1 * mean ( CD ) / \sqrt{{σ}_{1}^{2} + {σ}_{2}^{2}} \qquad ( Eq . 2 )$$

If this defect rate meets the desired boundary condition that M1 bridging between the first polygon 704 and the second polygon 708 should occur at a defect rate of less than 10⁻¹⁰, the layout geometry 700 is left unadjusted. If the predicted M1 bridging defect rate is greater than 10⁻¹⁰, then the spacing between the first polygon 704 and the second polygon 708 is increased by an amount that satisfies the defect rate boundary conditions.

FIG. 7B illustrates a layout geometry 750 in which the first polygon 704 is shifted upwards and the second polygon 708 is shifted downwards to increase the M1 spacing between the polygons to a spacing 716 that is greater than the spacing 712 in FIG. 7A. The increased spacing is realized by shifting both the first and second polygons but could have also been realized by shifting just one of the polygons or just shifting either or both of the edges 792 and 796 (without shifting either of the polygons). In practice, which polygons are shifted (or which polygon edges are adjusted) can depend on the layout geometry and the availability of space in the layout to accommodate the adjustment of a polygon edge. The original positions of the first polygon 704 and the second polygon 708 are illustrated in FIG. 7B by dashed lines 704′ and 708′, respectively. Adjusting an edge from its position in an integrated circuit layout to a different position in a photomask can comprise moving the edge to the left, right, top, or bottom.

While the example edge adjustment illustrated in FIGS. 7A-7B is based on the prediction of a single defect mode, in actual integrated circuit manufacturing processes, there are often multiple defect modes that can be considered. Often, adjustments made in a layout geometry to address the geometry's susceptibility to one particular defect mode can make it more susceptible to other defect modes, and it may not be straightforward to find a solution that optimizes a layout geometry for multiple defect modes. Because individual stochastic failure prediction models predict defect rates for a particular defect mode, a total defect rate for a layout geometry in which multiple defect modes are considered can be defined as follows:

$${log}_{10} ( total defect rate ) = {log}_{10} ( defect rate 1 + defect rate 2 ) + … ) , \qquad ( Eq . 3 )$$

where defect rate 1 and defect rate 2 are the predicted defect rates for different defect modes calculated according to Eq. 2.

In some embodiments, predicted defect rates are determined for a set of variations of a layout geometry. The individual variations have one or more edges adjusted from a base layout geometry—a layout geometry in an original integrated circuit design. The set of edges in the layout geometry selected for adjustment in the photomask layout can be the edges that are adjusted in any layout geometry variation for which the predicted defect rate is less than a threshold defect rate (e.g., 10⁻¹⁰). In other embodiments, the edges selected for adjustment are those that are adjusted in the layout geometry variation having the lowest predicted defect rate among the layer geometry variations. In embodiments where the multiple defect modes comprise defect models for different layers in a layout, the mask layout 520 can comprise edges on multiple layers adjusted from their position in the integrated circuit layout 508. The selection of edges for adjustment in a photomask layout based on multiple defect modes can provide a balance in reducing defect rates given layout constraints (e.g., the amount that edges in a layout geometry can be adjusted given their proximity to neighboring polygons).

In stage 504, optical proximity correction can be applied to the entirety of the integrated circuit layout 508. In some embodiments, this can be done by optical proximity correction being applied iteratively to subsets of the integrated circuit layout 508. For example, in embodiments where the integrated circuit layout 508 is a hierarchical layout, optical proximity correction can be applied to layout geometries in the layouts of the leaf cells in the integrated circuit layout hierarchy (i.e., the set of unique layouts that define the integrated circuit layout 508) to determine the set of edges that are to be adjusted in the leaf cell layouts. In some embodiments, after optical proximity correction has been performed on the leaf cell layouts, optical proximity correction can then be applied to interfaces between layout leaf cells and interfaces between intermediate layout leaf cells as the optical proximity correction process works its way up through the integrated circuit layout hierarchy.

In other embodiments, the optical proximity correction process can operate on a “flat” integrated circuit layout 508 that contains no hierarchy. In such embodiments, optical proximity correction can be run on the entire integrated circuit layout at once or iteratively over a set of layout geometries that each comprise a subset of the integrated circuit layout 508.

After optical proximity correction has been performed on the integrated circuit layout 508 to generate information representing the mask layout 520, the information representing the mask layout 520 can be forwarded to a mask writing tool. At stage 522, a photomask or reticle can be generated by the mask writing tool using the mask layout 520.

Mask validation 524 can be performed on the mask layout 520 to identify geometries in the mask layout that are likely defect sources. These layout geometries are identified by applying stochastic failure prediction models 528 and the defect rate model 516 to the mask layout 520. The stochastic failure prediction models 528 can be the same or a different set of SFP models than the SFP models 512 used during OPC. The mask validation 524 can identify layout geometries likely to be defect sources as those having a predicted defect rate that is greater than a defect rate threshold. This threshold can be the same as or different from any defect rate threshold used during optical proximity correction. In some embodiments, the mask validation 524 process can be exhaustive, and predicted defect rates can be generated based on every edge in the mask layout 520. The output of the mask validation 524 is likely defect source region data 532, which comprises information indicating one or more layout geometries of the mask layout 520 that have a high predicted defect rate. This information can be used, for example, during defect metrology to highlight layout geometries in failing integrated circuit components that are to be scanned for defects, to help develop or refine optical proximity correction recipes, or to drive changes in standard cell, bit cell, or other layout building blocks to help reduce defect rates in yet-to-be designed products for a particular semiconductor manufacturing technology.

In an experiment to demonstrate the benefits of using stochastic failure prediction models in optical proximity correction, stochastic failure prediction models modeling two defect modes for a particular photolithography process were utilized during optical proximity correction to make adjustments to a full chip integrated circuit layout. A photomask was taped out and a mask was generated based on the adjustment integrated circuit layout. Defect metrology showed that integrated circuit structures produced using the new photomask had a defect rate about ten times less than the defect rate of integrated circuit structures produced using a baseline mask comprising optical proximity corrections based on optical contrast and rule-based sizing.

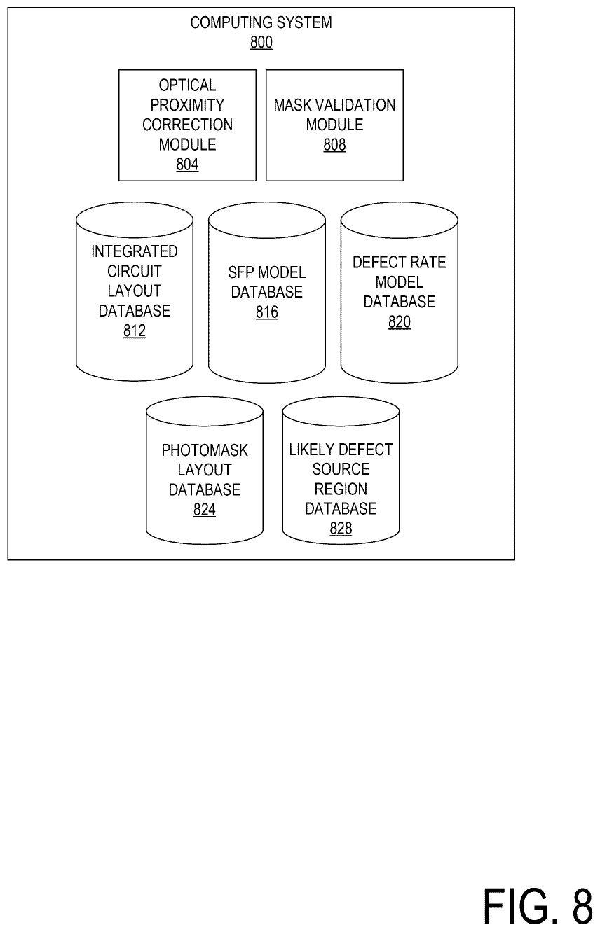

FIG. 8 is a block diagram of a first example computing system for performing optical proximity correction and mask validation an integrated circuit layout using stochastic failure prediction models. The computing system 800 comprises an optical proximity correction module 804 that performs optical proximity correction on integrated circuit layouts and a mask validation module 808 that performs mask validation on photomask layouts generated by the optical proximity correction module 804. The computing system 800 further comprises an integrated circuit layout database 812 that stores integrated circuit layouts that the optical proximity correction module 804 can act upon, a stochastic failure prediction model database 816 that stores stochastic failure prediction models utilized by the optical proximity correction module 804 and the mask validation module 808, a defect rate model database 820 that stores defect rate models used by the optical proximity correction module 804 and the mask validation module 808, a photomask database 824 that stores photomask layouts generated by the optical proximity correction module 804, and a likely defect source region database 828 database that stores information indicating layout geometries of photomask layouts that have a high predicted defect rate, as determined by the mask validation module 808. Although the databases illustrated in FIG. 8 are illustrated as being part of the computing system 800, in other embodiments, one or more of the illustrated databases can be external to the computing system 800.

It is to be understood that FIG. 8 illustrates one example of a set of modules that can be included in a computing device. In other embodiments, a computing device can have more or fewer modules than those shown in FIG. 8. For instance, the optical proximity correction module 804 and the mask validation module 808 may be included in separate computing systems. Further, separate modules can be combined into a single module, and a single module can be split into multiple modules. Moreover, any of the modules shown in FIG. 8 can be part of an operating system of the computing system 800, one or more software applications independent of the operating system, or operate at another software layer.

As used herein, the term “module” refers to logic that may be implemented in a hardware component or device, software or firmware running on a processor unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processor units, state machine circuitry, and/or firmware that stores instructions executable by programmable circuitry. Modules described herein may, collectively or individually, be embodied as circuitry that forms a part of a computing system. Thus, any of the modules can be implemented as circuitry, such as optical proximity correction circuitry or photomask validation circuitry. A computing system referred to as being programmed to perform a method can be programmed to perform the method via software, hardware, firmware, or combinations thereof.

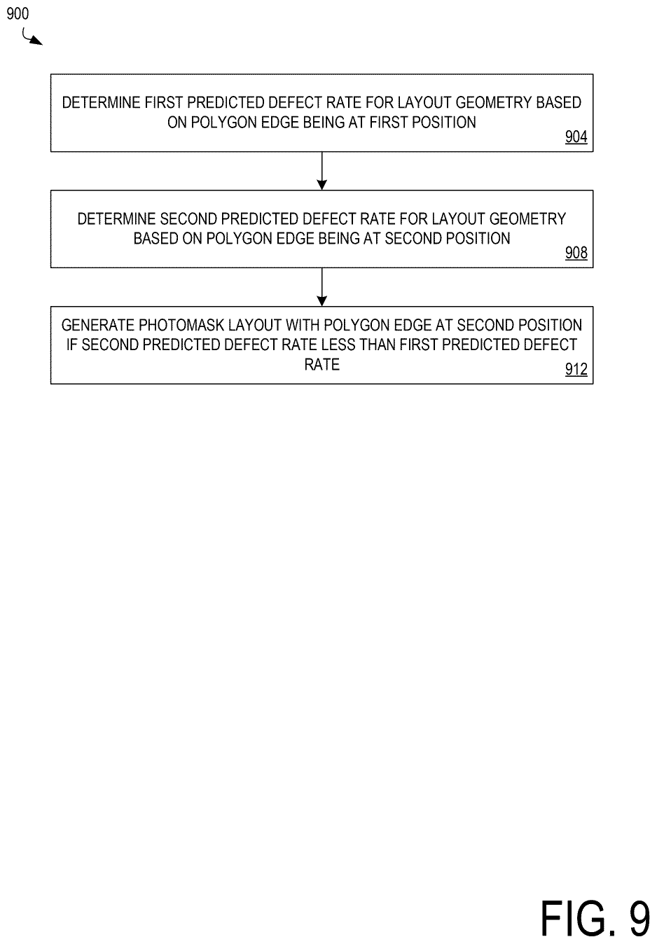

FIG. 9 is a first example method of performing optical proximity correction in an integrated circuit layout using stochastic failure prediction models. The method 900 can be formed by an integrated circuit component manufacturer. At stage 904 in method 900, a first predicted defect rate for a layout geometry of an integrated circuit layout is determined, wherein determining the first predicted defect rate is based on a defect rate model and a stochastic failure prediction model, wherein the first predicted defect rate is based on a dimension of the layout geometry, the dimension is associated with an edge of a polygon of the layout geometry, and the edge is located at a first position in the layout geometry. At stage 908, a second predicted defect rate for the layout geometry is determined, wherein determining the second predicted defect rate is based on the defect rate model and the stochastic failure prediction model, and the edge is located at a second position in the layout geometry. At stage 912, information representing a photomask layout is generated, wherein the photomask layout is based on the integrated circuit layout and the edge is located at the second position in the layout geometry in the photomask layout if the second predicted defect rate is less than the first predicted defect rate.

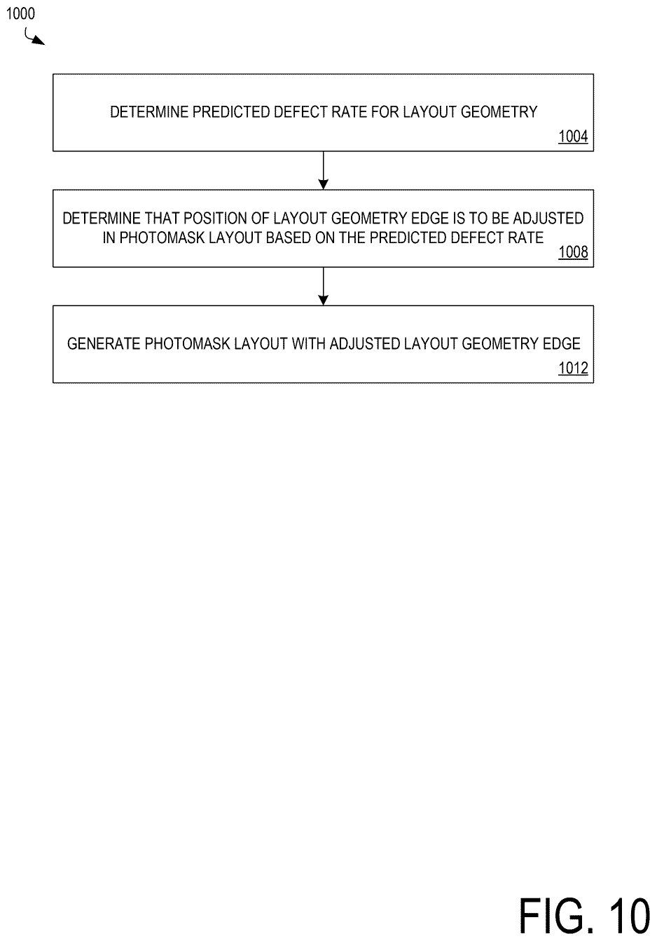

FIG. 10 is a second example method of performing optical proximity correction in an integrated circuit layout using stochastic failure prediction models. The method 1000 can be formed by an integrated circuit component manufacturer. At stage 1004, a predicted defect rate for a layout geometry of an integrated circuit layout is determined, wherein determining the predicted defect rate is based on a defect rate model and a stochastic failure prediction model. At stage 1008, that a position of an edge in the layout geometry is to be adjusted in a photomask layout is determined based on the predicted defect rate for the layout geometry, wherein the photomask layout is based on the integrated circuit layout. At stage 1012, information representing the photomask layout is generated, wherein a position of the edge in the photomask layout is adjusted relative to the position of the edge in the integrated circuit layout.

At stage 1004, a predicted defect rate for a layout geometry of an integrated circuit layout is determined, wherein determining the predicted defect rate is based on a defect rate model and a stochastic failure prediction model. At stage 1008, determining that a position of an edge of a polygon in the layout geometry is to be adjusted in a photomask layout is determined based on the predicted defect rate for the layout geometry, wherein the photomask layout is based on the integrated circuit layout. At stage 1012, generating information representing the photomask layout is generated, wherein a position of the edge in the layout geometry in the photomask layout is adjusted relative to the position of the edge in the layout geometry in the integrated circuit layout.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource. Furthermore, the terms “comprising,” “including,” “having,” and the like, as used with respect to embodiments of the present disclosure, are synonymous.

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

The technologies described herein can be performed by or implemented in any of a variety of computing systems, including mobile computing systems (e.g., laptop computers), non-mobile computing systems (e.g., desktop computers, servers, workstations, rack-level computing solutions (e.g., blade, tray, or sled computing systems)), and embedded computing systems (e.g., computing systems that are manufacturing equipment, such as a mask writing tool).

As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that hosts companies' applications and data), or an edge data center (e.g., a data center typically having a smaller footprint than other data center types, located close to the geographic area that it serves).

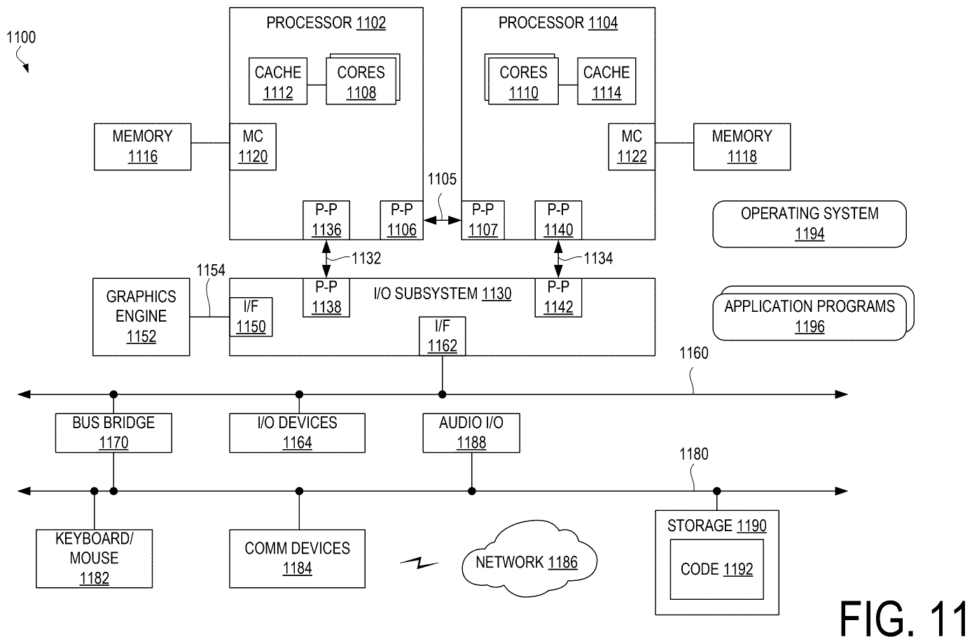

FIG. 11 is a block diagram of a second example computing system in which technologies described herein may be implemented. Generally, components shown in FIG. 11 can communicate with other shown components, although not all connections are shown, for ease of illustration. The computing system 1100 is a multiprocessor system comprising first processor unit 1102 and second processor unit 1104 comprising point-to-point (P-P) interconnects. A point-to-point (P-P) interface 1106 of the first processor unit 1102 is coupled to a point-to-point interface 1107 of the second processor unit 1104 via a point-to-point interconnection 1105. It is to be understood that any or all of the point-to-point interconnects illustrated in FIG. 11 can be alternatively implemented as a multi-drop bus, and that any or all buses illustrated in FIG. 11 could be replaced by point-to-point interconnects.

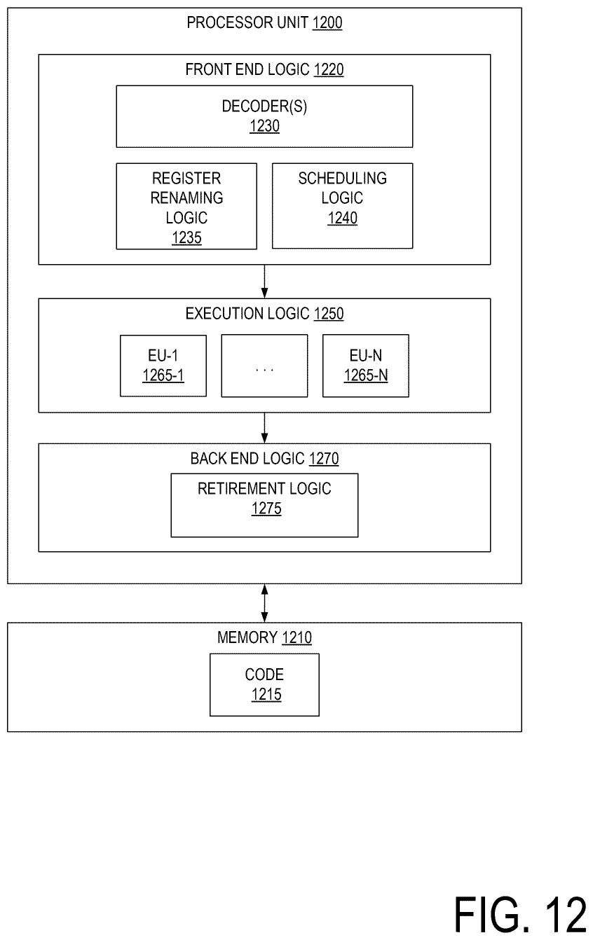

The first processor unit 1102 and second processor unit 1104 comprise multiple processor cores. The first processor unit 1102 comprises processor cores 1108 and the second processor unit 1104 comprises processor cores 1110. Processor cores 1108 and 1110 can execute computer-executable instructions in a manner similar to that discussed below in connection with FIG. 12, or other manners.

The first processor unit 1102 and the second processor unit 1104 further comprise cache memories 1112 and 1114, respectively. The cache memories 1112 and 1114 can store data (e.g., instructions) utilized by one or more components of the first processor unit 1102 and the second processor unit 1104, such as the processor cores 1108 and 1110. The cache memories 1112 and 1114 can be part of a memory hierarchy for the computing system 1100. For example, the cache memories 1112 can locally store data that is also stored in a first memory 1116 to allow for faster access to the data by the first processor unit 1102. In some embodiments, the cache memories 1112 and 1114 can comprise multiple cache memories that are a part of a memory hierarchy. The cache memories in the memory hierarchy can be at different cache memory levels, such as level 1 (L1), level 2 (L2), level 3 (L3), level 4 (L4), or other cache memory levels. In some embodiments, one or more levels of cache memory (e.g., L2, L3, L4) can be shared among multiple cores in a processor unit or among multiple processor units in an integrated circuit component. In some embodiments, the last level of cache memory in an integrated circuit component can be referred to as a last-level cache (LLC). One or more of the higher levels of cache levels (the smaller and faster cache memories) in the memory hierarchy can be located on the same integrated circuit die as a processor core and one or more of the lower cache levels (the larger and slower caches) can be located on one or more integrated circuit dies that are physically separate from the processor core integrated circuit dies.

Although the computing system 1100 is shown with two processor units, the computing system 1100 can comprise any number of processor units. Further, a processor unit can comprise any number of processor cores. A processor unit can take various forms such as a central processing unit (CPU), graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other type of processing unit. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 1100 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The first processor unit 1102 and the second processor unit 1104 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from any integrated circuit die containing a processor unit. In some embodiments, these separate integrated circuit dies can be referred to as “chiplets”. In some embodiments, where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by a package substrate, one or more silicon interposers, one or more silicon bridges embedded in a package substrate (such as Intel® embedded multi-die interconnect bridges (EMIBs)), or combinations thereof.

The first processor unit 1102 further comprises first memory controller logic (first MC 1120) and the second processor unit 1104 further comprises second memory controller logic (second MC 1122). As shown in FIG. 11, a first memory 1116 coupled to the first processor unit 1102 is controlled by the first MC 1120 and a second memory 1118 coupled to the second processor unit 1104 is controlled by the second MC 1122. The first memory 1116 and the second memory 1118 can comprise various types of volatile memory (e.g., dynamic random-access memory (DRAM), static random-access memory (SRAM)) and/or non-volatile memory (e.g., flash memory, chalcogenide-based phase-change non-volatile memories). The first memory 1116 and the second memory 1118 can comprise one or more layers of a memory hierarchy of the computing system. While first MC 1120 and second MC 1122 are illustrated as being integrated into the first processor unit 1102 and the second processor unit 1104, in alternative embodiments, memory controller logic can be external to a processor unit.

The first processor unit 1102 and the second processor unit 1104 are coupled to an Input/Output subsystem 1130 (I/O subsystem) via point-to-point interconnections 1132 and 1134. The point-to-point interconnection 1132 connects a point-to-point interface 1136 of the first processor unit 1102 with a point-to-point interface 1138 of the Input/Output subsystem 1130, and the point-to-point interconnection 1134 connects a point-to-point interface 1140 of the second processor unit 1104 with a point-to-point interface 1142 of the Input/Output subsystem 1130. Input/Output subsystem 1130 further includes an interface 1150 to couple the Input/Output subsystem 1130 to a graphics engine 1152. The Input/Output subsystem 1130 and the graphics engine 1152 are coupled via a bus 1154.

The Input/Output subsystem 1130 is further coupled to a first bus 1160 via an interface 1162. The first bus 1160 can be a Peripheral Component Interconnect Express (PCIe) bus or any other type of bus. Various I/O devices 1164 can be coupled to the first bus 1160. A bus bridge 1170 can couple the first bus 1160 to a second bus 1180. In some embodiments, the second bus 1180 can be a low pin count (LPC) bus. Various devices can be coupled to the second bus 1180 including, for example, a keyboard/mouse 1182, audio I/O devices 1188, and a storage device 1190, such as a hard disk drive, solid-state drive, or another storage device for storing computer-executable instructions (or code 1192) or data. The code 1192 can comprise computer-executable instructions for performing methods described herein. Additional components that can be coupled to the second bus 1180 include one or more communication devices 1184, which can provide for communication between the computing system 1100 and one or more wired or wireless networks 1186 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 502.11 standard and its supplements).

In embodiments where the one or more communication devices 1184 support wireless communication, the one or more communication devices 1184 can comprise wireless communication components coupled to one or more antennas to support communication between the computing system 1100 and external devices. The wireless communication components can support various wireless communication protocols and technologies. In addition, the wireless modems can support communication with one or more cellular networks for data and voice communications within a single cellular network, between cellular networks, or between the computing system and a public switched telephone network (PSTN).

The computing system 1100 can comprise removable memory such as flash memory cards (e.g., SD (Secure Digital) cards), memory sticks, Subscriber Identity Module (SIM) cards). The memory in computing system 1100 (including cache memories 1112 and 1114, first memory 1116, second memory 1118, and storage device 1190) can store data and/or computer-executable instructions for executing an operating system 1194 and application programs 1196. Example data includes integrated circuit layout data and photomask data to be sent to and/or received from one or more network servers or other devices by the computing system 1100 via the one or more wired or wireless networks 1186, or for use by the computing system 1100. The computing system 1100 can also have access to external memory or storage (not shown) such as external hard drives or cloud-based storage.

The operating system 1194 can control the allocation and usage of the components illustrated in FIG. 11 and support the application programs 1196. The application programs 1196 can include common computing system applications (e.g., email applications, calendars, contact managers, web browsers, messaging applications) as well as other computing applications, such as optical proximity correction and mask validation applications.

The computing system 1100 can support various additional input devices, such as a touchscreen, touchpad, trackpad, and one or more output devices, such as one or more displays. Any of the input or output devices can be internal to, external to, or removably attachable with the computing system 1100. External input and output devices can communicate with the computing system 1100 via wired or wireless connections.

The computing system 1100 can further include at least one input/output port comprising physical connectors (e.g., USB, FireWire, Ethernet, RS-232), a power supply (e.g., battery).

It is to be understood that FIG. 11 illustrates only one example computing system architecture. Computing systems based on alternative architectures can be used to implement technologies described herein. For example, instead of the first processor unit 1102, the second processor unit 1104, and the graphics engine 1152 being located on discrete integrated circuit dies, a computing system can comprise an SoC (system-on-a-chip) integrated circuit die on which multiple processors, a graphics engine, and additional components are incorporated. Further, a computing system can connect its constituent component via bus or point-to-point configurations different from that shown in FIG. 11. Moreover, the illustrated components in FIG. 11 are not required or all-inclusive, as shown components can be removed and other components added in alternative embodiments.

FIG. 12 is a block diagram of an example processor unit to execute computer-executable instructions as part of implementing technologies described herein. The processor unit 1200 can be a single-threaded core or a multithreaded core in that it may include more than one hardware thread context (or “logical processor”) per processor unit.

FIG. 12 also illustrates a memory 1210 coupled to the processor unit 1200. The memory 1210 can be any memory described herein or any other memory known to those of skill in the art. The memory 1210 can store computer-executable instructions 1215 (code) executable by the processor unit 1200.

The processor unit comprises front-end logic 1220 that receives instructions from the memory 1210. An instruction can be processed by one or more decoders 1230. The one or more decoders 1230 can generate as its output a micro-operation such as a fixed width micro-operation in a predefined format, or generate other instructions, microinstructions, or control signals, which reflect the original code instruction. The front-end logic 1220 further comprises register renaming logic 1235 and scheduling logic 1240, which generally allocate resources and queues operations corresponding to converting an instruction for execution.

The processor unit 1200 further comprises execution logic 1250, which comprises one or more execution units (EUs) (execution unit 1265-1 through execution unit 1265-N). Some processor unit embodiments can include a number of execution units dedicated to specific functions or sets of functions. Other embodiments can include only one execution unit or one execution unit that can perform a particular function. The execution logic 1250 performs the operations specified by code instructions. After completion of execution of the operations specified by the code instructions, back-end logic 1270 retires instructions using retirement logic 1275. In some embodiments, the processor unit 1200 allows out of order execution but requires in-order retirement of instructions. Retirement logic 1275 can take a variety of forms as known to those of skill in the art (e.g., re-order buffers or the like).

The processor unit 1200 is transformed during execution of instructions, at least in terms of the output generated by the one or more decoders 1230, hardware registers and tables utilized by the register renaming logic 1235, and any registers (not shown) modified by the execution logic 1250.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a method comprising: determining a first predicted defect rate for a layout geometry of an integrated circuit layout, wherein determining the first predicted defect rate is based on a defect rate model and a stochastic failure prediction model, wherein the first predicted defect rate is based on a dimension of the layout geometry, the dimension is associated with an edge of a polygon of the layout geometry, and the edge is located at a first position in the layout geometry; determining a second predicted defect rate for the layout geometry, wherein determining the second predicted defect rate is based on the defect rate model and the stochastic failure prediction model, and the edge is located at a second position in the layout geometry; and generating information representing a photomask layout, wherein the photomask layout is based on the integrated circuit layout and the edge is located at the second position in the layout geometry in the photomask layout if the second predicted defect rate is less than the first predicted defect rate.

Example 2 comprises the method of example 1, wherein determining the first predicted defect rate comprises: generating, using the stochastic failure prediction model and with the edge located at the first position in the integrated circuit layout, an average placement of the edge and a standard deviation of a placement of the edge; determining a mean of the dimension and a standard deviation of the dimension based on the average placement of the edge and the standard deviation of the placement of the edge; and determining, using the defect rate model, the first predicted defect rate based on the mean of the dimension and the standard deviation of the dimension.

Example 3 is a method comprising: determining a predicted defect rate for a layout geometry of an integrated circuit layout, wherein determining the predicted defect rate is based on a defect rate model and a stochastic failure prediction model; determining that a position of an edge of a polygon in the layout geometry is to be adjusted in a photomask layout based on the predicted defect rate for the layout geometry, wherein the photomask layout is based on the integrated circuit layout; and generating information representing the photomask layout, wherein a position of the edge in the layout geometry in the photomask layout is adjusted relative to the position of the edge in the layout geometry in the integrated circuit layout.

Example 4 comprises the method of example 3, wherein determining the predicted defect rate comprises: generating, using the stochastic failure prediction model, an average placement of the edge and a standard deviation of a placement of the edge; determining, based on the average placement of the edge and the standard deviation of the placement of the edge, a mean of a dimension of the layout geometry and a standard deviation of the dimension, the dimension associated with the edge; and determining, using the defect rate model, the predicted defect rate based on the mean of the dimension and the standard deviation of the dimension.

Example 5 comprises the method of example 3 or 4, wherein determining that the position of the edge in the layout geometry is to be adjusted in the photomask layout comprises determining that the predicted defect rate is greater than a defect rate threshold.

Example 6 comprises the method of example 3 or 4, wherein: determining the predicted defect rate for the layout geometry is iteratively performed on one or more variations of the layout geometry, wherein individual iterations of determining the predicted defect rate generate an iteration predicted defect rate; and determining that the position of the edge of the layout geometry is to be adjusted in the photomask layout comprises determining that the position of the edge is to be adjusted to the position of the edge in a variation of the one or more variations of the layout geometry having a lowest iteration predicted defect rate.

Example 7 comprises the method of any one of examples 3-6, wherein: the stochastic failure prediction model is a first stochastic failure prediction model that models a first defect mode; determining the predicted defect rate for a layout geometry is further based on a second stochastic failure prediction model that models a second defect mode; and determining that the position of the edge in the layout geometry is to be adjusted in the photomask layout is further based on the second stochastic failure prediction model.

Example 8 comprises the method of example 7, wherein the first defect mode is associated with a first layer of the integrated circuit layout, the edge is a first edge on the first layer of the integrated circuit layout, and the second defect mode is associated with a second layer of the integrated circuit layout; the method further comprising determining that a position of a second edge on the second layer in the layout geometry is to be adjusted in the photomask layout based on the defect rate model and the second stochastic failure prediction model, wherein the position of the second edge in the photomask layout is adjusted relative to the position of the second edge in the layout geometry.

Example 9 comprises the method of any one of examples 3-4 and 6, wherein the layout geometry is a first layout geometry, the method further comprising: determining a predicted defect rate for a second layout geometry of integrated circuit layout, wherein determining the predicted defect rate for the second layout geometry is based on the defect rate model and the stochastic failure prediction model; and in response to determining that the predicted defect rate for the second layout geometry is greater than a defect rate threshold, identifying the second layout geometry as a likely defect source.

Example 10 comprises the method of any one of examples 1-6, wherein the stochastic failure prediction model comprises an edge placement sub-model and an edge variability sub-model.

Example 11 comprises the method of example 1-6, further comprising calibrating the stochastic failure prediction model based on a plurality of simulated two-dimensional optical images.

Example 12 comprises the method of any one of examples 1-11, further comprising forwarding the photomask layout to a mask writing tool for generation of a photomask or a reticle.

Example 13 comprises the method of example 1-11, further comprising generating a photomask or reticle based on the photomask layout.

Example 14 comprises the method of any one of examples 1-13, further comprising: generating the defect rate model based on a plurality of critical dimension mean-to-standard deviation ratios, wherein: individual of the plurality of critical dimension mean-to-standard deviation ratios are based on a plurality of critical dimension measurements associated with a layout geometry, a layout geometry dimension, and wafer exposure conditions triplet, individual of the plurality of critical dimension mean-to-standard deviation ratios associated with a different a layout geometry, a layout geometry dimension, and wafer exposure conditions triplet.

Example 15 comprises the method of any one of examples 1-13, wherein the defect rate model is a linear regression model.

Example 16 is one or more computer-readable storage media storing computer-executable instructions that, when executed, cause a computing system to perform the method of any one of examples 1-15.

Example 17 is a computing system comprising: one or more processors; and one or more computer-readable storage media storing computer-executable instructions that, when executed by the one or more processors, cause the one or more processors to perform the method of any one of examples 1-15.

Example 18 is an apparatus comprising a means to perform any one of the method of examples 1-15.

Example 19 is one or more computer-readable storage media storing computer-executable instructions that, when executed, cause a computing system to: determine a predicted defect rate for a dimension of a layout geometry of an integrated circuit layout, wherein determining the predicted defect rate is based on a defect rate model and a stochastic failure prediction model; determine that a position of an edge in the layout geometry is to be adjusted in a photomask layout based on the predicted defect rate for the dimension, wherein the photomask layout is based on the integrated circuit layout; and generate information representing the photomask layout, wherein a position of the edge in the photomask layout is adjusted relative to the position of the edge in the layout geometry.

Example 20 comprises the one or more computer-readable storage media of example 19, wherein the computer-executable instructions, when executed, further cause the computing system to: generate, using the stochastic failure prediction model, an average placement of the edge and a standard deviation of a placement of the edge; determine an average of the dimension and a standard deviation of the dimension based on the average placement of the edge and the standard deviation of the placement of the edge; and determine, using the defect rate model, the predicted defect rate based on the average of the dimension and a standard deviation of the dimension.

Example 21 comprises the one or more computer-readable storage media of example 19, wherein to determine that the position of the edge in the layout geometry is to be adjusted in the photomask layout comprises to determine that the predicted defect rate is greater than a defect rate threshold.

Example 22 comprises the one or more computer-readable storage media of example 19, wherein: to determine the predicted defect rate for the dimension is iteratively performed on one or more variations of the layout geometry, wherein individual iterations of determining the predicted defect rate generate an iteration predicted defect rate; and to determine that the position of the edge of the layout geometry is to be adjusted in the photomask layout comprises determining that the position of the edge is to be adjusted to the position of the edge in a variation of the one or more variations of the layout geometry having a lowest iteration predicted defect rate.

Example 23 comprises the one or more computer-readable storage media of example 19, wherein: the stochastic failure prediction model is a first stochastic failure prediction model that models a first defect mode; determining the predicted defect rate for a layout geometry is further based on a second stochastic failure prediction model that models a second defect mode; and determining that the position of the edge in the layout geometry is to be adjusted in the photomask layout is further based on the second stochastic failure prediction model.

Example 24 comprises the one or more computer-readable storage media of example 19, wherein the layout geometry is a first layout geometry, the computer-executable instructions, when executed, further cause the computing system to: determine a predicted defect rate for an edge in a second layout geometry that is part of a plurality, wherein to determine the predicted defect rate is based on the defect rate model and the stochastic failure prediction model; and in response to determining that the predicted defect rate for the second layout geometry is greater than a defect rate threshold, to identify the edge in the second layout geometry as a likely defect source.

1. A method comprising:
determining a predicted defect rate for a layout geometry of an integrated circuit layout, wherein determining the predicted defect rate is based on a defect rate model and a stochastic failure prediction model;
determining that a position of an edge of a polygon in the layout geometry is to be adjusted in a photomask layout based on the predicted defect rate for the layout geometry, wherein the photomask layout is based on the integrated circuit layout; and
generating information representing the photomask layout, wherein a position of the edge in the layout geometry in the photomask layout is adjusted relative to the position of the edge in the layout geometry in the integrated circuit layout.

2. The method of claim 1, wherein determining the predicted defect rate comprises:
generating, using the stochastic failure prediction model, an average placement of the edge and a standard deviation of a placement of the edge;
determining, based on the average placement of the edge and the standard deviation of the placement of the edge, a mean of a dimension of the layout geometry and a standard deviation of the dimension, the dimension associated with the edge; and
determining, using the defect rate model, the predicted defect rate based on the mean of the dimension and the standard deviation of the dimension.

3. The method of claim 1, wherein determining that the position of the edge in the layout geometry is to be adjusted in the photomask layout comprises determining that the predicted defect rate is greater than a defect rate threshold.

4. The method of claim 1, wherein:
determining the predicted defect rate for the layout geometry is iteratively performed on one or more variations of the layout geometry, wherein individual iterations of determining the predicted defect rate generate a variation predicted defect rate; and
determining that the position of the edge of the layout geometry is to be adjusted in the photomask layout comprises determining that the position of the edge is to be adjusted to the position of the edge in a variation of the one or more variations of the layout geometry having a lowest variation predicted defect rate.

5. The method of claim 1, wherein:
the stochastic failure prediction model is a first stochastic failure prediction model that models a first defect mode;
determining the predicted defect rate for a layout geometry is further based on a second stochastic failure prediction model that models a second defect mode; and
determining that the position of the edge in the layout geometry is to be adjusted in the photomask layout is further based on the second stochastic failure prediction model.

6. The method of claim 5, wherein the first defect mode is associated with a first layer of the integrated circuit layout, the edge is a first edge on the first layer of the integrated circuit layout, and the second defect mode is associated with a second layer of the integrated circuit layout; the method further comprising determining that a position of a second edge on the second layer in the layout geometry is to be adjusted in the photomask layout based on the defect rate model and the second stochastic failure prediction model, wherein the position of the second edge in the photomask layout is adjusted relative to the position of the second edge in the layout geometry.

7. The method of claim 1, wherein the layout geometry is a first layout geometry, the method further comprising:
determining a predicted defect rate for a second layout geometry of integrated circuit layout, wherein determining the predicted defect rate for the second layout geometry is based on the defect rate model and the stochastic failure prediction model; and
in response to determining that the predicted defect rate for the second layout geometry is greater than a defect rate threshold, identifying the second layout geometry as a likely defect source.

8. The method of claim 1, further comprising generating a photomask or reticle based on the photomask layout.

9. A method comprising:
determining a first predicted defect rate for a layout geometry of an integrated circuit layout, wherein determining the first predicted defect rate is based on a defect rate model and a stochastic failure prediction model, wherein the first predicted defect rate is based on a dimension of the layout geometry, the dimension is associated with an edge of a polygon of the layout geometry, and the edge is located at a first position in the layout geometry;
determining a second predicted defect rate for the layout geometry, wherein determining the second predicted defect rate is based on the defect rate model and the stochastic failure prediction model, and the edge is located at a second position in the layout geometry; and
generating information representing a photomask layout, wherein the photomask layout is based on the integrated circuit layout and the edge is located at the second position in the layout geometry in the photomask layout if the second predicted defect rate is less than the first predicted defect rate.

10. The method of claim 9, wherein determining the first predicted defect rate comprises:
generating, using the stochastic failure prediction model and with the edge located at the first position in the integrated circuit layout, an average placement of the edge and a standard deviation of a placement of the edge;
determining a mean of the dimension and a standard deviation of the dimension based on the average placement of the edge and the standard deviation of the placement of the edge; and
determining, using the defect rate model, the first predicted defect rate based on the mean of the dimension and the standard deviation of the dimension.

11. The method of claim 9, wherein:
the stochastic failure prediction model is a first stochastic failure prediction model that models a first defect mode; and
determining the first predicted defect rate for a layout geometry is further based on a second stochastic failure prediction model that models a second defect mode.

12. The method of claim 9, wherein the layout geometry is a first layout geometry, the method further comprising:
determining a predicted defect rate for a second layout geometry of integrated circuit layout, wherein determining the predicted defect rate for the second layout geometry is based on the defect rate model and the stochastic failure prediction model; and
in response to determining that the predicted defect rate for the second layout geometry is greater than a defect rate threshold, identifying the second layout geometry as a likely defect source.

13. The method of claim 9, further comprising forwarding the photomask layout to a mask writing tool for generation of a photomask or a reticle.

14. One or more computer-readable storage media storing computer-executable instructions that, when executed, cause a computing system to:
determine a predicted defect rate for a dimension of a layout geometry of an integrated circuit layout, wherein determining the predicted defect rate is based on a defect rate model and a stochastic failure prediction model;
determine that a position of an edge in the layout geometry is to be adjusted in a photomask layout based on the predicted defect rate for the dimension, wherein the photomask layout is based on the integrated circuit layout; and
generate information representing the photomask layout, wherein a position of the edge in the photomask layout is adjusted relative to the position of the edge in the layout geometry.

15. The one or more computer-readable storage media of claim 14, wherein the computer-executable instructions, when executed, further cause the computing system to:
generate, using the stochastic failure prediction model, an average placement of the edge and a standard deviation of a placement of the edge;
determine an average of the dimension and a standard deviation of the dimension based on the average placement of the edge and the standard deviation of the placement of the edge; and
determine, using the defect rate model, the predicted defect rate based on the average of the dimension and a standard deviation of the dimension.

16. The one or more computer-readable storage media of claim 14, wherein to determine that the position of the edge in the layout geometry is to be adjusted in the photomask layout comprises to determine that the predicted defect rate is greater than a defect rate threshold.

17. The one or more computer-readable storage media of claim 14, wherein:
to determine the predicted defect rate for the dimension is iteratively performed on one or more variations of the layout geometry, wherein individual iterations of determining the predicted defect rate generate a variation predicted defect rate; and
to determine that the position of the edge of the layout geometry is to be adjusted in the photomask layout comprises determining that the position of the edge is to be adjusted to the position of the edge in a variation of the one or more variations of the layout geometry having a lowest variation predicted defect rate.

18. The one or more computer-readable storage media of claim 14, wherein:
the stochastic failure prediction model is a first stochastic failure prediction model that models a first defect mode;
determining the predicted defect rate for a layout geometry is further based on a second stochastic failure prediction model that models a second defect mode; and
determining that the position of the edge in the layout geometry is to be adjusted in the photomask layout is further based on the second stochastic failure prediction model.

19. The one or more computer-readable storage media of claim 14, wherein the layout geometry is a first layout geometry, the computer-executable instructions, when executed, further cause the computing system to:
determine a predicted defect rate for an edge in a second layout geometry that is part of a plurality, wherein to determine the predicted defect rate is based on the defect rate model and the stochastic failure prediction model; and
in response to determining that the predicted defect rate for the second layout geometry is greater than a defect rate threshold, to identify the edge in the second layout geometry as a likely defect source.

20. The one or more computer-readable storage media of claim 14, the computer-executable instructions, when executed, further cause the computing system to forward the information representing the photomask layout to a mask writing tool.
